(19) United States
(12) Patent Application Publication
(10) Pub. No.: US 2007/0003905 A1
(43) Pub. Date: Jan. 4, 2007

(54) Tooth whitening apparatus and methods for whitening teeth using an intra-oral light generating device

(75) Inventors: Bao Luu Nguyen, Diamond Bar, CA (US); Liet Hong Nguyen, Garden Grove, CA (US)

Correspondence Address: LAN Q. NGO, ESQ., SUITE 275, 9950 WESTPARK DR., HOUSTON, TX, 77063, US

(73) Assignee: NOVOCAL, LLC

(21) Appl. No.: 11/174,216

(22) Filed: Jul. 1, 2005

(51) Int. Cl. A61C 5/00; A61C 1/00

(52) U.S. Cl. 433/215; 433/29

(57) ABSTRACT

A tooth whitening apparatus and method using an intra-oral light generating device, whereas the light generating device is placed inside a patient's mouth and bucally to the jaws to produce a light source, comprises the steps of applying inside a means for depositing and applying, adapted for the upper and lower jaws, a tooth whitening agent comprising an optical chemical agent. Said means for depositing and applying are made of suitable material comprising plastic, and adapted inside the patient's mouth and adjacent to the inner surface of the patient's lips. The method further includes the steps of placing the means for depositing and applying filled with a light-activated, tooth whitening agent into the patient's mouth, onto the corresponding jaws and positioning the light generating device, inside the patient's mouth, bucally to the jaws, whereas the intra-oral light is located adjacent to surface of the means for depositing-and-applying, and on the inner surface of the cheeks and lips of the mouth of said patient. Therein the intra-oral light activates the tooth whitening agent for a period of time.

### FIELD OF INVENTION

The present field of invention relates to methods and apparatus for whitening teeth, and more particularly, to methods of whitening teeth using adapted means for depositing and applying tooth whitening agent, which comprises optical chemical agent, and apparatus equipped with intra-oral light generating device, whereby the device is capable of emitting light inside patient or user's mouth.

### BACKGROUND OF THE INVENTION

U.S. Pat. No. 6,884,426 discloses that tooth whitening has become popular in today's culture. More and more consumers are searching for the best method to achieve tooth whitening. Professional tooth bleach by a dentist is common. Generally, there are two types of professional tooth bleaching: (i) in the dentist's office, or (ii) outside of the dentist's office. In the office tooth bleaching generally involves several visits to the dentist and the use of a rubber dam to protect the patient's gums from the bleaching agents, and the use of an extra-oral light source or heat source. Out of the office tooth bleaching generally involves the use of a device or means for depositing-and-applying, which is made in the dental office to fit the patient's teeth. The device is reused, and therefore, must be sufficiently robust to endure repeat handling, cleaning, filling, installation, and wearing. Typically, a patient uses the device in time periods when social contact can be avoided.

Furthermore, there are now non-professional programs available to persons interested in whitening their teeth using commercial products available at drug stores. The commercial products provide a kit, which includes a generic appliance and a container of bleaching gel. The obvious appeal is the lower cost of the program. A major disadvantage of this generic “one size fits all” appliance is the greater void space between the interior walls of the appliance and the teeth versus a professionally fitted appliance. Hence, in order to insure intimate contact of the bleaching gel and the teeth surfaces, more bleaching gel is required. Furthermore, the poorer fit means a greater loss of bleaching gel onto the gums, into the oral cavity, and eventual ingestion. The commercial kits, and the outside-the-office professionally administered programs, require the user to clean and to reuse the appliance. Since generic appliances are not fitted to the individual user, they are even more bulky in the mouth than the fitted appliances and thus they restrict social discourse to a greater degree.

One attempt to remedy some of the problems of the commercial kits is disclosed in U.S. Pat. No. 5,575,654, issued to Fontenot on Nov. 19, 1996. Fontenot discloses a prepackaged moldable dental appliance adapted to fit a wide range of variously sized dental arches. In use, the dental appliance is removed from the packaging, aligned in a parallel fashion to the edges of the teeth and pushed over the teeth in the direction of the periodontal tissue until it covers the teeth surfaces.

Another solution is disclosed in U.S. Pat. No. 5,310,563, issued to Curtis et al. on May 10, 1994. Curtis et al. disclose a putty-like material, which is formed by pressing against the teeth. It is held in place by mechanical engagement with undercut surfaces and by friction. The composition encapsulates the active material.

Other methods are disclosed in U.S. Pat. No. 5,425,953, issued to Sintov et al. on Jun. 20, 1995. Sintov et al. discloses a liquid polymer composition for bleaching of the teeth. The liquid polymer composition forms a film after applied to the teeth. Other references, which disclose using a film in the oral cavity include U.S. Pat. No. 4,713,243 issued to Schiraldi et al. on Dec. 15, 1987, and U.S. Pat. No. 2,835,628, issued to Saffir on May 20, 1958.

U.S. Pat. No. 6,884,426 discloses methods for whitening teeth are provided. The methods include the steps of providing a strip of material and applying a thin layer of a tooth whitening substance having a whitening active selected from the group consisting of peroxides, metal chlorites, perborates, percarbonates, peroxyacids, hypochlorites, and combinations thereof to a front surface of a plurality of teeth, wherein the amount of the tooth whitening substance is between about 0.05 grams and about 0.4 grams. The method further includes the steps of conforming the strip of material to the front surface of the plurality of teeth and removing the strip of material, wherein the front surface of the plurality of teeth have between a 1 and a 4 VITA LUMIN shade guide improvement in tooth color.

U.S. Pat. No. 6,752,627 discloses a light emitting tooth brush having whitening and sterilizing effects, wherein the light emitting member of the circuit board may emit ultraviolet rays with shorter wavelengths (with a greater energy), thereby provide a light emitting tooth brush having whitening and sterilizing effects, wherein the light emitting tooth brush may promote the optical chemical reaction between the tooth paste and the surface of the user's teeth, so that the light emitting tooth brush may clean and whiten the surface of the user's teeth efficiently, thereby achieving the effect of cleaning and whitening the user's teeth.

Furthermore, patent U.S. Pat. No. 6,752,627 discloses a light emitting tooth brush having whitening and sterilizing effects, comprising a handle having one end provided with a light permeable brush head, a control switch mounted in the handle, and a circuit board mounted in the brush head, wherein: the circuit board is electrically connected to the control switch, and is provided with a light emitting member which may emit optical waves having a specified wavelength through the light permeable brush head.

The Ionophoresis (or Iontophoresis) Principle:

Ionophoresis (or iontophoresis—the terms ionophoresis and iontophoresis are synonymous) is used in Medicine and Dentistry for more than 7 decades. The principle consists of applying a galvanic current to a substance to facilitate its osmotic penetration into the human body.

lonophoresis (or iontophoresis) is used in Dentistry mostly for:
a) The treatment of dental abscess during the root canal therapy when the penetration of ions into the abscessed area brings anti-infectious and anti-inflammatory results.
b) The improved absorption of local topical anesthetic gel, by accelerating the rate and the depth of absorption of the gel submitted under a low voltage galvanic current.
c) The topical application of fluoride gel onto the tooth surfaces.

A detailed description of the ionophoresis (or iontophoresis) in the application of fluoride gel is necessary as background to further understanding of the present invention.

Ionophoresis (or Iontophoresis) in the Application of Fluoride Gel on the Teeth

The fluor component is present in the gel in its ionic form Fl-, where the atom is charged negatively. The gel is loaded into a sponge that can be wrapped around the dental arch. A rigid holder is placed on top of that sponge to hold it during the operation.
The holder is made of plastic material, with a metal wire embedded. The metal wire is in direct contact with the sponge imbibed with the Fluoride gel.
The metal wire is connected to a Negative electrode of a low direct voltage galvanic current. A 9 v battery maybe used for that effect.
A positive electrode is connected to a metallic handle held by the patient.
The application time is usually from 5 to 10 minutes.

The patient's body is charged with a positive current through the handle, as such the tooth surface is positively charged. The Fluoride gel is negatively charged by the metal wire, which connected to the negative electrode. Under the galvanic current a process occurs: the fluoride ions Fl- are drawn from the gel media by the reaction of the negatively charged gel, and in the same time they are attracted toward the positively charged tooth surface. Such process increases the rate and the depth of penetration of Fl- into the enamel where it reacts with the Hydroxy-apatite prisms (main constituent of the enamel) and forms the Fluoro-apatite prisms that are much more acid resistant (bacteria resistant).

Application of Ionophoresis (or Iontophoresis) in the Bleaching Process:

When the peroxide gel (carbamide peroxide or hydrogen peroxide) is applied to the tooth surface in the bleaching process, the main active ingredient H2O2 is decomposed into various ions H+, OH—, H2O—, O—. The free radical OH— is the most efficient in breaking down the chromogen macro molecules that constitute the dark colored stains on the tooth. Once those molecules are broken down into smaller molecules, they loose the color and eventually become invisible.

Applying the ionophoresis (or iontophoresis) principle to the bleaching process increases the rate and the depth of penetration of ions OH— into the tooth surface.

### SUMMARY OF THE INVENTION

Methods for whitening teeth are provided and apparatus with light emitting device having whitening effects are provided. The methods include the steps of providing means for depositing and applying a whitening substance comprising of optical chemical agent, providing an intra-oral light emitting device, adapting said means for depositing and applying to a plurality of the teeth, and subjecting the means for depositing and applying to a light of said intra-oral light emitting device.

In accordance with the present invention, the apparatus being provided comprises a means for depositing and applying having optically receptive material thereby permitting transmission of the intra-oral light, which activates said optical chemical agent, and thereby achieving the whitening effect of said substance. Furthermore, the light emitting device provides the intra-oral light thereby achieves the optical chemical reaction between the substance and the user's teeth so that the teeth are whitened sufficiently.

### DETAILED DESCRIPTION

According to the present invention, patient and user are used intermittingly and understood in this context to be one as much as the other.

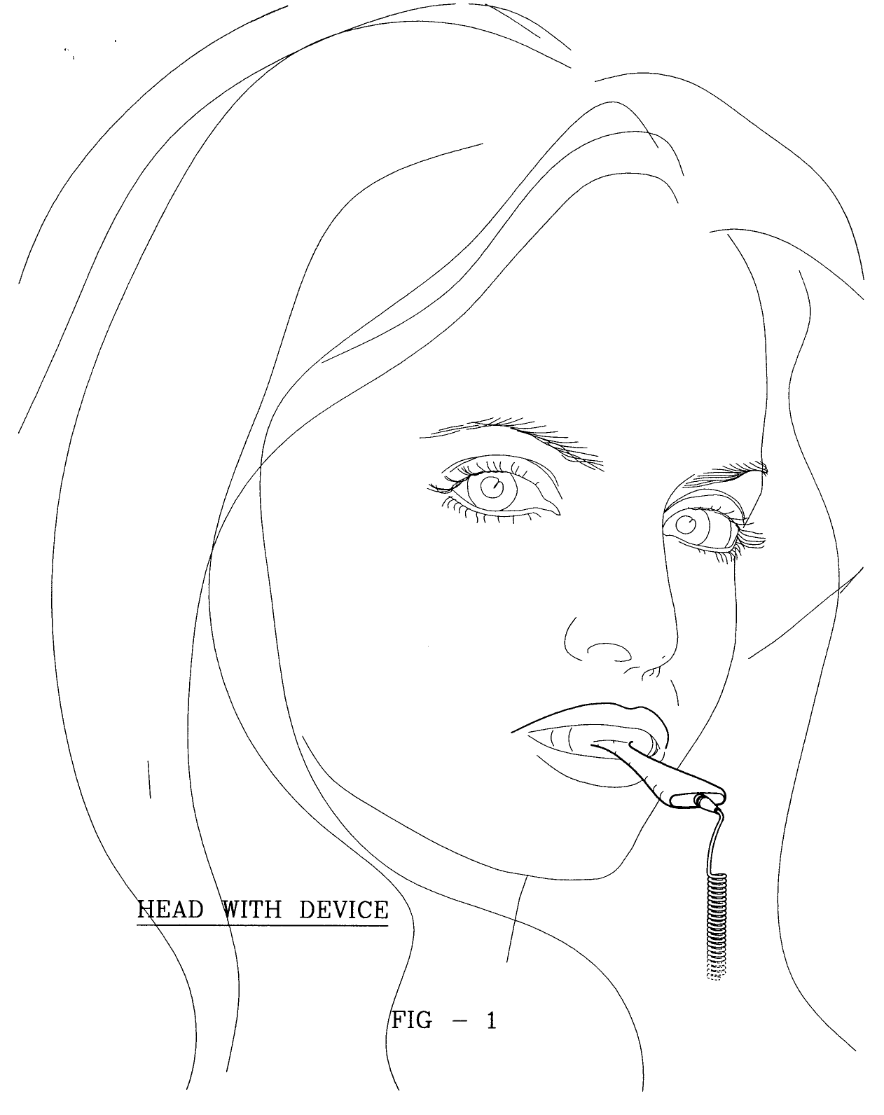

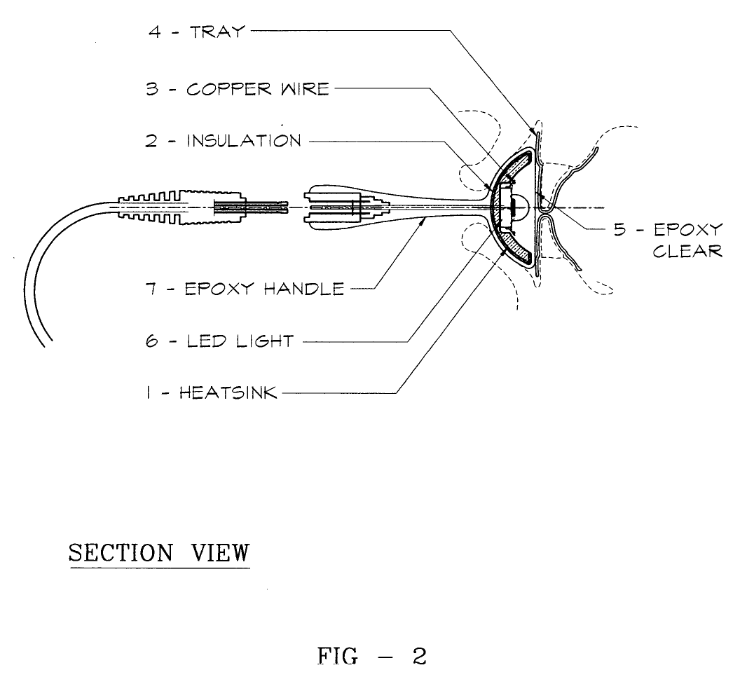

In FIG. 1, an upper means for depositing and applying (4) and a lower bleaching means for depositing and applying (4), adapted according to patient's upper jaw and lower jaw are fabricated from a predetermined standard model, or from the patient's dental molding from an impression of the plurality of the patient's teeth or from the whole section of patient's jaw. The patient's moldings are made using the usual dental impression techniques employed in dental offices following generally accepted dental laboratory process.

A tooth whitening substance is applied in predetermined location of the area adjacent to the teeth inside the means for depositing and applying. The tooth whitening substance comprises an optical chemical agent, comprising camphor quinone, and selected from a group of components comprising hydrogen peroxide, carbamide peroxide and chlorine dioxide.

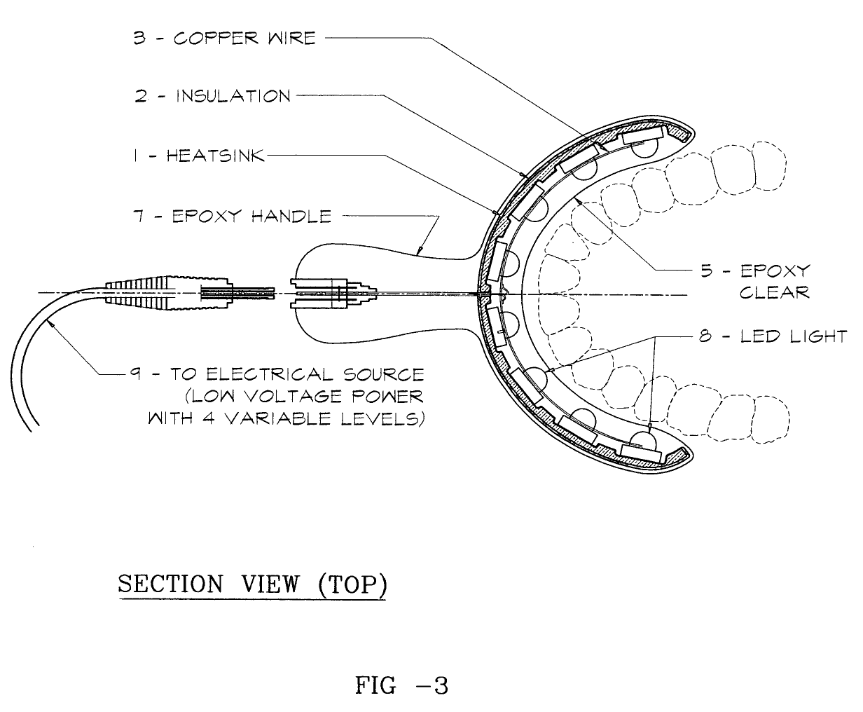

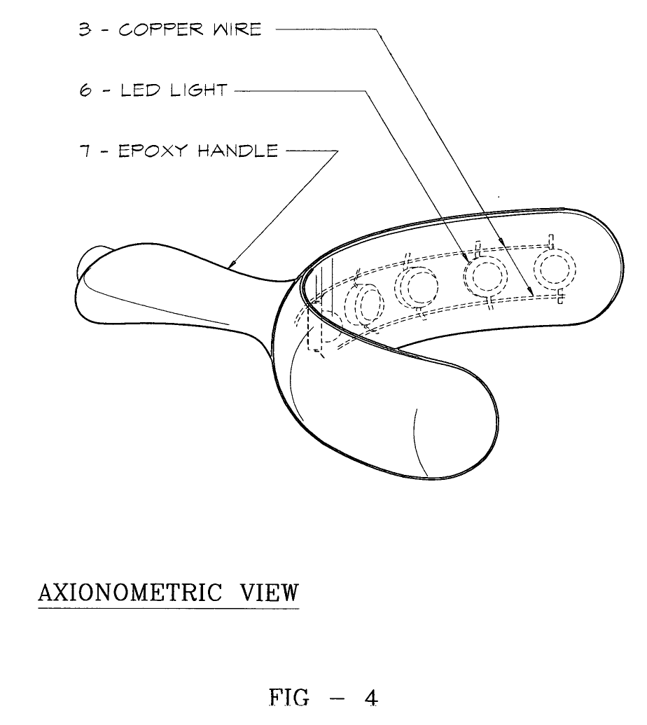

In FIG. 2, the light-generating device (6) is inserted inside the patient's mouth. Said device (6) occupies the space between the buccal surface of the teeth and the inside surface of the cheeks and lips, and provides a sufficient source of illumination for the tooth whitening substance previously applied and contained inside the means for depositing and applying, thereby effectively activates said catalyst.

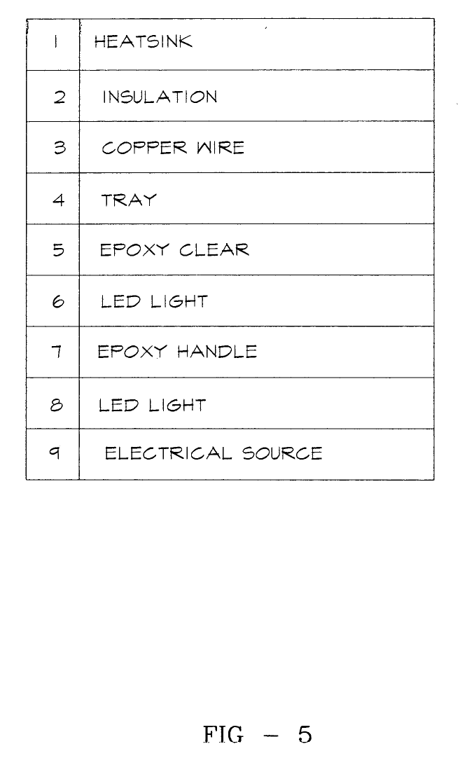

In FIG. 3, an electrical power supply (or supplies) is provided by connecting to (9) thereby provides power to the device light emitting device (6) and thus to LED lights (8) which transmit sufficient light and heat to the tooth whitening substance in place and in the means for depositing and applying, and to maintain illumination within a range of wavelengths recommended by the manufacturer of said optical chemical agent, and for a period of time recommended by the whitening substance manufacturer or the user's dentist. LED is the acronym for light emitting diode.

According to one of the preferred embodiment, the wavelengths for said light emitting device (6), the bleaching application time and temperatures as related and applied are respectively in the following ranges: wavelengths are between 400 to 500 nanometers, application time is between 5 to 60 minutes, and temperature is between 35° C. to 50° C. and alternately between 35° C. to 80° C.

More particularly, the invention provides a light source from the light emitting device (6), which is adapted to the inside of the user's mouth in comparison to a light source, which is located externally. Furthermore, this is a direct light source from the light emitting diode (LED) 8 as the light is emitting from the inside of user's mouth and not light conducted from an external light source.

The light generating device (6) comprises a plurality of small LED's (light emitting diodes) 8 to provide an apparently uniformed high intensity light.

More particularly, the LED's 8 are mounted inside a frame of curved shape, which is adapted to treat substantially the full area of the dental arches on the buccal side of the teeth and adapted to the upper and lower arches. Furthermore, the frame is adapted to a plurality of shape in conjunction of a variety of materials suitable for the device to locate comfortably inside the patient's mouth and be tolerated by the patient. Alternately, the device is adapted to treat part of the area of the dental arches in accordance with the desire of the patient and alternately by the recommendation of the relevant medical practitioner.

Furthermore, the LED's 8 emit a uniformed high intensity light whereas the power source is an electrical low voltage source. Alternately, such power is produced from a step down power source.

More particularly, the device in this invention differs from existing light-activating bleaching devices, which are available in the market, thereby provides an intra-oral light source, which is designed for the patient to keep in her mouth during the tooth whitening process. It is also important that the right wavelength to activate the optical-chemical agent and chemical agent be achieved without creating excessive heat. More particularly, the LED's 8 are used because they emit the right wavelength to activate the optical-chemical agent and chemical agent without creating excessive heat as they are unlike the halogen and other incandescent light sources. Furthermore, the low voltage light-generating device is portable, which allows patients greater mobility and alternately the patient is able to accomplish tooth whitening at diverse location included but not limited to patient's residence.

Alternately, other light emitting elements, which can be adapted to the inside of the patient's mouth and be tolerated by the patient, can replace the LED's 8.

In addition to procuring the necessary light to activate the light activated whitening substance, the device emits non-excessive heat, which is tolerable to the patient as the heat accelerates the chemical reaction. The heat may be generated from the device's soldering element, which acts as an electrical resistance, and alternately other electrical resistance present and, alternately by other heating means. Light and heat may act in synergy to secure the desired whitening effect.

It is noted that the invention has been described in details, which are related to its preferred embodiment as mentioned above and shall not be limited thereof. Therefore, many other possible modifications and variations can be made without departing from the scope of the present invention as they are covered in the claims for such variations and modifications that fall within the true scope of this invention.

We claim:

1. An intra-oral light generating device comprising:
a) a frame having suitable shape adapted to the inside of the patient's mouth and a plurality of light emitting elements;
b) a heat source of tolerable temperatures;
c) an electrical power supply connected to said light emitting elements; and,
d) an electrical power supply sufficiently generates the heat source.

2. An intra-oral light generating device as in claim 1 wherein the frame having an internal side directed toward the teeth is concave in the horizontal plane and in the vertical plane with the internal side directed toward the teeth, comprising:
a) a row of LED's, which is located in the center of the frame in the vertical plane, directing the light toward the teeth;
b) a heat source to maintain temperatures of said frame in a range tolerable by the patient whereas said heat source originating from the frame, which is made of metal and, which acts as a heat sink for the LED's; and
c) said electrical power supply has an integral power means to vary the power.

3. An apparatus for tooth whitening comprising an intra-oral light generating device as in claim 1 comprising:
a) a light activated tooth whitening agent a composition including but not limited to an optical chemical agent and a whitening product;
b) an upper means for depositing and applying for the upper dental arch, and a lower means for depositing and applying for the lower dental arch of said patient; and
c) an electrical power supply adapted to provide power to said light emitting elements, thereby provides illumination and heat to said tooth whitening agent placed in said bleaching means for depositing and applying for a predetermined wavelengths and for a period of time.

4. An apparatus as in claim 3 wherein the illumination wavelength achieved by said light emitting elements is in the range between 400-500 nanometers.

5. An apparatus as in claims 3 wherein the temperature is further restricted to the range of 35-80° Celsius.

6. An apparatus as in claims 3 wherein the temperature is in the range of 35-80° Celsius, and wherein the illumination wavelength of light emitting elements is in the range between 400 to 500 nanometers.

7. An apparatus as in claim 3 wherein the bleaching application time is in the range of 5-60 minutes.

8. An apparatus as in claim 3 wherein the bleaching application time is in the range of 5-60 minutes, and wherein the temperature is in the range from 35° to 80° Celsius.

9. A method for whitening tooth surfaces, which comprises:
a) using an impressionable material to make a patient's dental impression, which captures the appearance of the patient's tooth surfaces;
b) making a replica of said dental impression in dental stone and alternately in plaster;
c) fabricating a dental means for depositing and applying from said replica, which covers said surfaces and said bleaching means for depositing and applying is made of suitable material for patient's comfort and achieving the whitening effects for patient's teeth;
d) applying to said means for depositing and applying a light activated tooth whitening substance comprises an optical chemical agent, including camphor quinone and a whitening composition selected from a group comprising of carbamide peroxide, hydrogen peroxide and chlorine dioxide;
e) inserting said means for depositing and applying into the patient's mouth and covering the patient's teeth with the means for depositing and applying;
f) inserting into the patient's mouth an intra-oral light generating device for illuminating and heating the patient's teeth wherein
i) the device having an internal side, which faces the buccal surface of the teeth, is adapted with light emitting elements which comprises LED;
ii) an adaptable heat source to maintain a tolerable temperature range inside the patient's mouth and said heat source is provided from elements comprising of the device soldering material, electrical resistance, the light emitting elements, and heating means necessary to activate the whitening effects.
g) providing electrical power to the light emitting elements for illumination and heat to said tooth whitening agent placed in said means for depositing and applying with a wavelength to effect the whitening process of the optical chemical agent; and
h) maintaining said intra-oral light generating device frame illuminated for period of time to effect the whitening process of the whitening substance.

10. A method as in claim 9 wherein the illumination wavelength of said light emitting elements is in the range of 400 to 500 nanometers.

11. A method as in claims 9 wherein the temperature comprises a range from 35° to 80° Celsius.

12. A method as in claims 9 wherein the temperature comprises a range from 35° to 80° Celsius and the illumination wavelength of light emitting elements is in the range of 400 to 500 nanometers.

13. A method as in claims 9 wherein the bleaching application time is in the range of 5-60 minutes.

14. A method as in claims 9 wherein the bleaching application time is in the range of 5-60 minutes and the illumination wavelength of light emitting elements is in the range of 400 to 500 nanometers.

15. A method as in claims 9 wherein the bleaching application time is in the range of 5-60 minutes, wherein the temperature comprises a range from 35° to 80° Celsius, and wherein the illumination wavelength of light emitting elements is in the range of 400 to 500 nanometers.

16. A method for whitening tooth surfaces comprises:
a) using a tooth whitening delivery apparatus wherein the tooth whitening delivery apparatus comprising adaptable dental means for depositing and applying whitening product, which can be adjusted for a plurality of diverse formation of the dental arch, covers the facial surfaces of the plurality of adjacent teeth;
b) applying a light-activated tooth whitening agent comprising an optical chemical agent including camphor quinone, and a whitening product selected from a group comprising carbamide peroxide, hydrogen peroxide and chlorine dioxide inside said means for depositing and applying;
c) inserting said means for depositing and applying into the patient's mouth and covering the patient's teeth with the means for depositing and applying;
d) inserting into the patient's mouth an intra-oral light generating device for illuminating and heating the patient's teeth wherein
i) the device having an internal side, which faces the buccal surface of the teeth, is adapted with light emitting elements which comprises LED;
ii) an adaptable heat source to maintain a tolerable temperature range inside the patient's mouth and said heat source is provided from elements comprising of the device soldering material, electrical resistance, the light emitting elements, and heating means necessary to activate the whitening effects.
e) providing electrical power to the light emitting elements for illumination and heat to said tooth whitening agent placed in said means for depositing and applying with a wavelength to effect the whitening process of the optical-chemical and chemical agent; and,
f) maintaining said intra-oral light generating device frame illuminated for period of time to effect the whitening process of the whitening substance.

17. A method as in claim 16 wherein the illumination wavelength of said light emitting elements is in the range of 400 to 500 nanometers.

18. A method as in claims 16 wherein the temperature comprises a range from 35° to 80° Celsius.

19. A method as in claims 16 wherein the temperature comprises a range from 35° to 80° Celsius and wherein the illumination wavelength of light emitting elements is in the range of 400 to 500 nanometers.

20. A method as in claims 16 wherein the bleaching application time is in the range of 5 -60 minutes.

21. A method as in claims 16 wherein the bleaching application time is in the range of 5-60 minutes, and wherein the temperature comprises a range from 35° to 80° Celsius.

22. A method as in claim 16 wherein the bleaching application time is in the range of 5-60 minutes, and wherein the illumination wavelength of light emitting elements is in the range of 400 to 500 nanometers.

23. A method as in claim 16 wherein the bleaching application time is in the range of 5-60 minutes; wherein the illumination wavelength of light emitting elements is in the range or 400 to 500 nanometers, and wherein the temperature comprises a range from 35° to 80° Celsius.

24. An apparatus to whiten teeth, comprising:
a) an intra-oral light generating device with the device having an internal side, which faces the buccal surface of the teeth, is adapted with light emitting elements which comprises LED's and light bulbs;
b) a light activated tooth whitening substance comprises an optical-chemical agent and chemical agent including camphor quinone, and a whitening composition selected from a group comprising of carbamide peroxide, hydrogen peroxide and chlorine dioxide;
c) means for depositing and applying for dental arch;
d) an electrical power supply to said light emitting elements for illuminating said tooth whitening agent applied in said means for depositing and applying with a wavelength to effect the whitening process of the optical chemical agent.

25. An apparatus as in claim 24 wherein the illumination wavelength of said light emitting elements is in the range of 400 to 500 nanometers.

26. An apparatus as in claim 24 wherein the bleaching application time is in the range of 5-60 minutes, and wherein the illumination wavelength of light emitting element is in the range of 400 to 500 nanometers.

27. A method for whitening tooth surfaces, which comprises:
a) using an impressionable material to make a patient's dental impression, which captures the appearance of the patient's tooth surfaces;
b) making a replica of said dental impression in dental stone and alternately in plaster;
c) developing a dental bleaching means for depositing and applying from said replica, which covers said surfaces and said means for depositing and applying is made of suitable material for patient's comfort and achieving the whitening effects for patient's teeth;
d) applying to said means for depositing and applying a light activated tooth whitening substance comprises an optical chemical agent including camphor quinone and a whitening composition selected from a group comprising of carbamide peroxide, hydrogen peroxide and chlorine dioxide;
e) inserting said means for depositing and applying into the patient's mouth and covering the patient's teeth with the means for depositing and applying;
f) inserting into the patient's mouth an intra-oral light generating device for illuminating and heating the patient's teeth wherein the device having an internal side, which faces the buccal surface of the teeth, is adapted with light emitting elements which comprises LED's and light bulbs necessary to effect the whitening process;
g) providing electrical power to the light emitting elements for illumination to said tooth whitening agent placed in said means for depositing and applying with a wavelength to effect the whitening process of the optical chemical agent; and
h) maintaining said intra-oral light generating device frame illuminated for period of time to effect the whitening process of the whitening substance.

28. A method as in claim 27 wherein the illumination wavelength of said light emitting elements is in the range of 400 to 500 nanometers.

29. A method as in claims 27 wherein the bleaching application time is in the range of 5-60 minutes, and wherein the illumination wavelength of light emitting elements is in the range of 400 to 500 nanometers.

30. A method for whitening tooth surfaces comprises:
a) using a tooth whitening delivery apparatus wherein the tooth whitening delivery apparatus comprising adaptable dental means for depositing and applying, which can be adjusted for a plurality of diverse formation of the dental arch, covers the facial surfaces of the plurality of adjacent teeth;
b) applying a light activated tooth whitening agent comprising an optical chemical agent including camphor quinone, and a whitening product selected from a group comprising carbamide peroxide, hydrogen peroxide and chlorine dioxide inside said means for depositing and applying;
c) inserting said bleaching means for depositing and applying into the patient's mouth and covering the patient's teeth with the means for depositing and applying;
d) inserting into the patient's mouth an intra-oral light generating device for illuminating and heating the patient's teeth wherein the device having an internal side, which faces the buccal surface of the teeth, is adapted with light emitting elements which comprises LED's and light bulbs;
e) providing electrical power to the light emitting elements for illumination to said tooth whitening agent placed in said means for depositing and applying with a wavelength to effect the whitening process of the optical-chemical agent; and
f) maintaining said intra-oral light generating device frame illuminated for period of time to effect the whitening process of the whitening substance.

31. A method as in claim 30 wherein the illumination wavelength of said light emitting elements is in the range of 400 to 500 nanometers.

32. A method as in claims 30 wherein the bleaching application time is in the range of 5-60 minutes, and wherein the illumination wavelength of light emitting elements is in the range of 400 to 500 nanometers.

33. An apparatus to whiten teeth, comprising:
a) an intra-oral light generating device with the device having an internal side, which faces the buccal surface of the teeth, is adapted with light emitting elements which comprises LED's and light bulbs, and an adaptable heat source to maintain a tolerable temperature range inside the patient's mouth and said heat source is provided from elements comprising of the device soldering material, electrical resistance, the light emitting elements, and heating means necessary to activate the whitening effects;
b) a light activated tooth whitening substance comprises an optical chemical agent and chemical agent including camphor quinone, and a whitening composition selected from a group comprising of carbamide peroxide, hydrogen peroxide and chlorine dioxide;
c) a means for depositing and applying said substance for the upper dental arch and the lower dental arch; and
d) an electrical power supply for said light emitting elements with a wavelength to effect the whitening process of the optical chemical agent.

34. An apparatus as in claim 33 wherein the temperature is in the range of 35° to 80° Celsius.

35. A apparatus as in claim 33 wherein the bleaching application time is in the range of 5-60 minutes, and wherein the temperature is in the range of 35° to 80° Celsius.

36. A method for whitening tooth surfaces using the principle of ionophoresis, which comprises:
a) Applying the metallic to a means for depositing and applying tooth whitening substance.
b) Connecting the filament to a negative electrode of a low direct voltage galvanic current.
c) Connecting a positive electrode to the patient's body.
d) Connecting an electric power source to said electrodes.

37. A method as in claim 36 wherein said metallic filament is replaced by an electrical conductive paint.

38. A method as in claim 36 wherein said metallic filament is replaced by means for adapting the electrodes to contact with the bleaching gel and the patient's body.

39. A method as in claim 30 wherein a means for depositing and applying tooth whitening substance is adapted for ionophoresis.
